(19) United States
(12) Patent Application Publication
(10) Pub. No.: US 2013/0067708 A1
(43) Pub. Date: Mar. 21, 2013

(54) Position Adjustable Chain Tool

(71) Applicant: Chung-Tsun Kuo, Dacun Township (TW)

(72) Inventor: Chung-Tsun Kuo, Dacun Township (TW)

(21) Appl. No.: 13/541,817

(22) Filed: Jul. 5, 2012

(30) Foreign Application Priority Data
Sep. 20, 2011 (TW) 100133702

(51) Int. Cl. B25B 27/22

(52) U.S. Cl. 29/258

(57) ABSTRACT

A position adjustable chain tool contains a body including a fixed holder, the fixed holder including a vertical extension with a cutout, the body including a through thread hole corresponding to the cutout; a movable seat between the fixed holder and the through thread hole, the movable seat having a horizontal sliding block and a longitudinal panel; a displacement controlling means between the body and the movable seat to control the movable seat to move between the fixed holder and the through thread hole by using the horizontal sliding block; a rotatable lever including a thread rod screwed with the through thread hole of the body, the thread rod having a pushing portion on one end thereof to correspond to the cutout of the fixed holder, the pushing portion matching with the through thread hole by using the thread rod so that the pushing portion moves axially in the cutout.

### BACKGROUND OF THE INVENTION

1. Field of the Invention

The present invention relates to a chain tool, and more particularly to a position adjustable chain tool to remove a chain easily.

2. Description of the Prior Art

A conventional chain tool comprises a body, a rotatable lever, and a pushing screw, wherein the body includes a groove defined on one side thereof, the groove has a first screw hole and a second screw hole, both of which are formed on two side surfaces of the groove, and the groove also has an upright holder disposed therein to place a chain. The rotatable lever is connected with the first screw hole of the body and includes an abutting portion formed on a front end thereof. The pushing screw includes a central orifice and is screwed with the second screw hole of the body. Thereby, while adjusting, maintaining, and replacing the chain, the chain is placed on the upright holder of the groove of the body, and due to the chain is in different sizes, the different sizes of chains have a plurality of sub-sections in different widths, the pushing screw is rotated to move the upright holder forward so that a connecting piece of the chain is retained between the pushing screw and the upright holder of the body to position the chain, then a coupling pin for removing the chain aligns with the abutting portion of the rotatable lever and the central orifice of the pushing screw without movement because of an external force, hence the rotatable lever is rotated to move forward so that the abutting portion pushes the coupling pin of the chain outward, thereafter the chain is removed.

Nevertheless, the conventional chain tool still has the following defects:

1. In a chain removing operation, the pushing screw is rotated manually by a user to move the upright holder forward so that the connecting piece of the chain is retained between the pushing screw and the upright holder of the body to remove the chain. Thereafter, the pushing screw is manually rotated in an opposite direction to return back to its original position, thus having troublesome operation.

2. Except for the first screw hole of the body, the second screw hole is defined in the body to rotate the pushing screw, and the pushing screw has the central orifice to align with the abutting portion of the rotatable lever so as to remove the chain smoothly, thereby increasing manufacture precision and production cost of the second screw hole of the body of the conventional chain tool.

The present invention has arisen to mitigate and/or obviate the afore-described disadvantages.

### SUMMARY OF THE INVENTION

The primary object of the present invention is to provide a position adjustable chain tool which removes the chain easily and quickly, wherein as removing the chain, the chain is placed on the longitudinal panel of the movable seat, and the movable seat is moved toward the vertical extension of the fixed holder by using the displacement controlling means so that the connecting piece of the chain is retained between the longitudinal panel of the movable seat and the vertical extension of the fixed holder, hence the chain is fixed at an alignment position without movement because of the external force, thus removing the chain easily and quickly.

Another object of the present invention is to provide a position adjustable chain tool which is simplified to lower production cost.

A position adjustable chain tool in accordance with a preferred embodiment of the present invention contains:

a body including a fixed holder disposed on one side thereof, the fixed holder including a vertical extension, and the vertical extension having a cutout, the body including a through thread hole arranged on one side surface thereof and corresponding to the cutout;

a movable seat fixed between the fixed holder and the through thread hole, the movable seat having a horizontal sliding block and a longitudinal panel;

a displacement controlling means defined between the body and the movable seat to control the movable seat to move between the fixed holder and the through thread hole by ways of the horizontal sliding block; and

a rotatable lever including a thread rod screwed with the through thread hole of the body, the thread rod having a pushing portion on one end thereof to correspond to the cutout of the fixed holder, the pushing portion matching with the through thread hole by ways of the thread rod so that the pushing portion moves axially in the cutout.

### BRIEF DESCRIPTION OF THE DRAWINGS

FIG. 1 is a perspective view showing the exploded components of a position adjustable chain tool according to a first embodiment of the present invention.

FIG. 2 is a perspective view showing the assembly of the position adjustable chain tool according to the first embodiment of the present invention.

FIG. 3 is a partial cross-sectional view showing the assembly of the position adjustable chain tool according to the first embodiment of the present invention.

FIG. 4 is a side plan view showing the operation of the position adjustable chain tool according to the first embodiment of the present invention.

FIG. 5 is another partial cross-sectional view showing the operation of the position adjustable chain tool according to the first embodiment of the present invention.

FIG. 6 is another side plan view showing the operation of the position adjustable chain tool according to the first embodiment of the present invention.

FIG. 7 is also another partial cross-sectional view showing the operation of the position adjustable chain tool according to the first embodiment of the present invention.

FIG. 8 is a top plan view showing the operation of the position adjustable chain tool according to the first embodiment of the present invention.

FIG. 9 is a partial cross-sectional view showing the assembly of a position adjustable chain tool according to a second embodiment of the present invention.

FIG. 10 is a partial cross-sectional view showing the assembly of a position adjustable chain tool according to a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

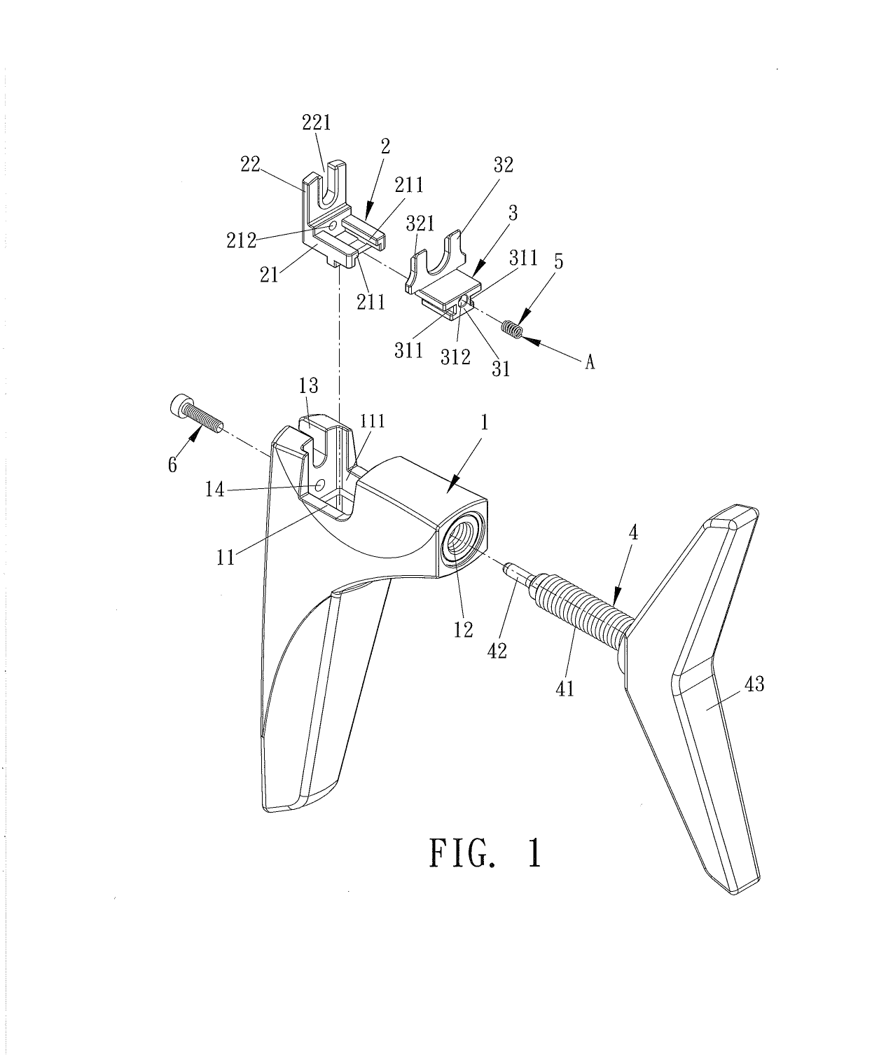

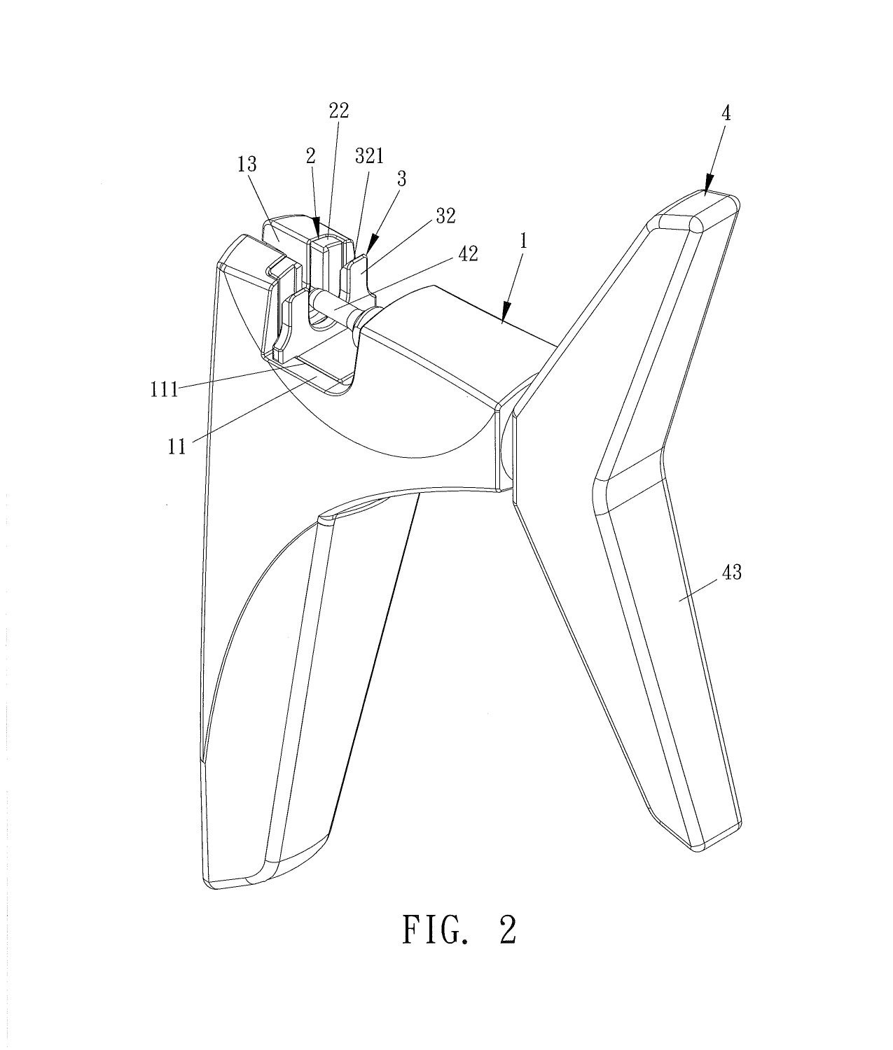

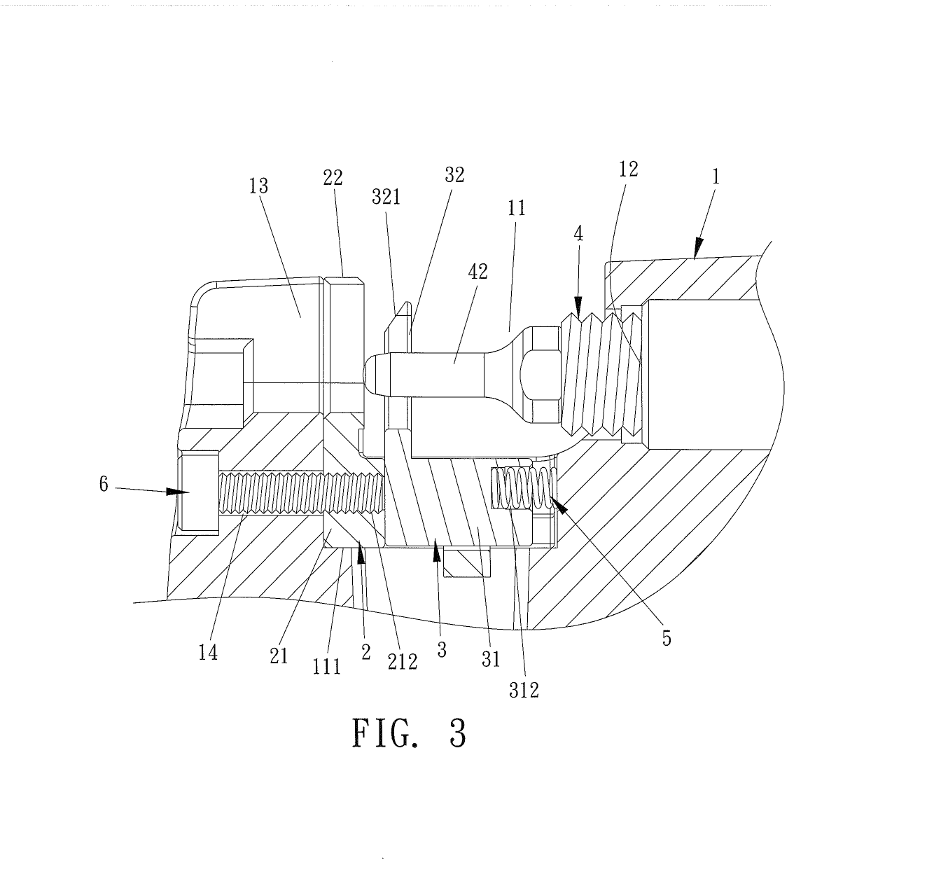

Referring to FIGS. 1-3, a position adjustable chain tool according to a first embodiment of the present invention comprises a body 1, a fixed holder 2, and a movable seat 3, a displacement controlling means A, and a rotatable lever 4, wherein the body 1 includes a U-shaped groove 11, the U-shaped groove 11 has a through thread hole 12 defined on one side surface thereof, a U-shaped recess 13 and a through orifice 14, both of which are formed on another side surface of the U-shaped groove 11 relative to the one side surface of the U-shaped groove 11. The U-shaped groove 11 also has an indentation 111 defined therein. The fixed holder 2 is formed in a L shape and includes a lateral extension 21 and a vertical extension 22 connected with the lateral extension 21. The lateral extension 21 has two opposite slidable rails 211 extending inward from two sides thereof and a screw aperture 212 arranged on a side surface thereof. The vertical extension 22 has a cutout 221 defined on a middle section thereof and corresponding to the through thread hole 12 of the body 1. The movable seat 3 is formed in a L shape and has a horizontal sliding block 31 and a longitudinal panel 32 connected with the horizontal sliding block 31 on which two opposite slots 311 are formed. The longitudinal panel 32 includes a tilted guiding portion 321 disposed on an upper end thereof. The displacement controlling means A includes a notch 312 and a resilient element 5, and the notch 312 is defined on one end of the horizontal sliding block 31 of the movable seat 3, the resilient element 5 is a spring. The rotatable lever 4 includes a thread rod 41 which has a pushing portion 42 on one end of the thread rod 41 and a rotary handle 43 on another end of the thread rod 41.

In assembly, the two opposite slots 311 of the movable seat 3 are retained with the two opposite slidable rails 211 of the fixed holder 2 so that the tilted guiding portion 321 of the longitudinal panel 32 of the movable seat 3 faces to the vertical extension 22 of the fixed holder 2, and one end of the resilient element 5 is fitted into the notch 312 of the horizontal sliding block 31 of the movable seat 3, thereafter the fixed holder 2, the movable seat 3, and the resilient element 5 are fixed in the U-shaped groove 11 of the body 1 so that the lateral extension 21 and the vertical extension 22 of the fixed holder 2 are retained in the indentation 111 of the U-shaped groove 11 of the body 1, and a screw 6 is screwed into the screw aperture 212 of the lateral extension 21 of the fixed holder 2 via the through orifice 14 of the body 1 so that the fixed holder 2 connects with the body 1, wherein the movable seat 3 is fixed between the fixed holder 2 and the through thread hole 12 of the body 1, and another end of the resilient element 5 is biased against one side wall of the indentation 111 of the body 1 so that the movable seat 3 pushes toward the vertical extension 22 of the fixed holder 2, and the rotatable lever 4 screws with the through thread hole 12 of the body 1 by rotating the thread rod 41 so that the pushing portion 42 of the rotatable lever 4 corresponds to the cutout 221 of the vertical extension 22 of the fixed holder 2, hence the pushing portion 42 of the rotatable lever 4 moves axially in the cutout 221 of the vertical extension 22, thereby assembling the position adjustable chain tool.

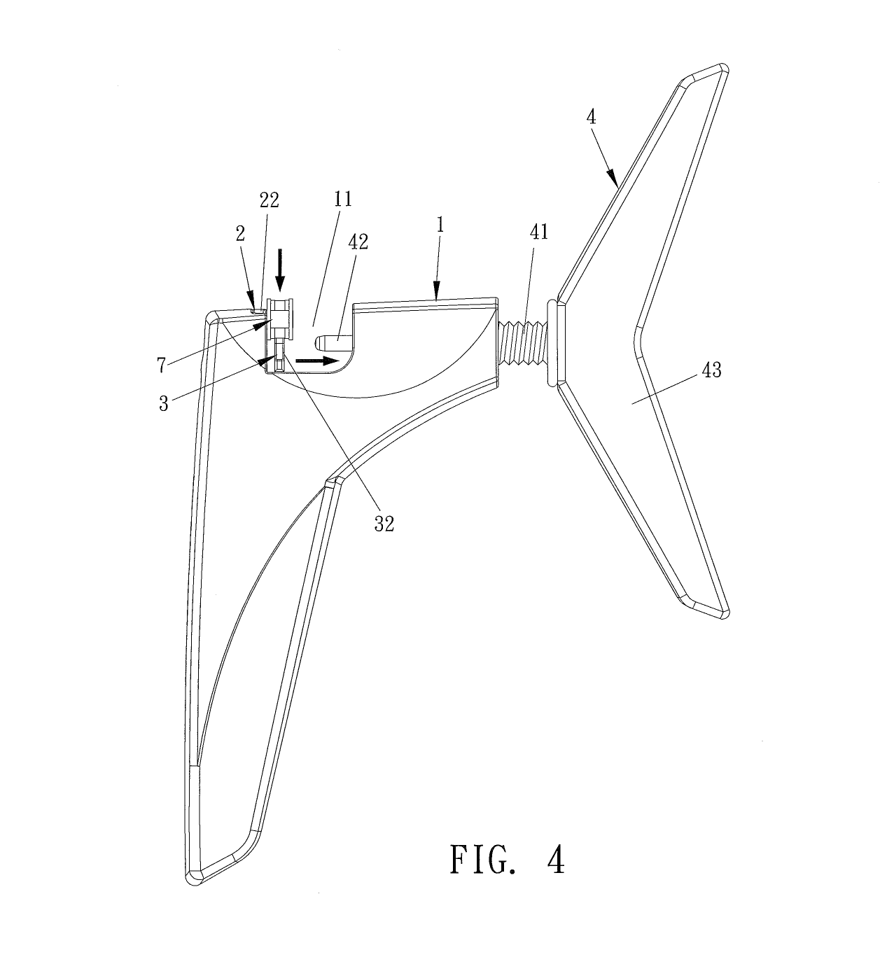

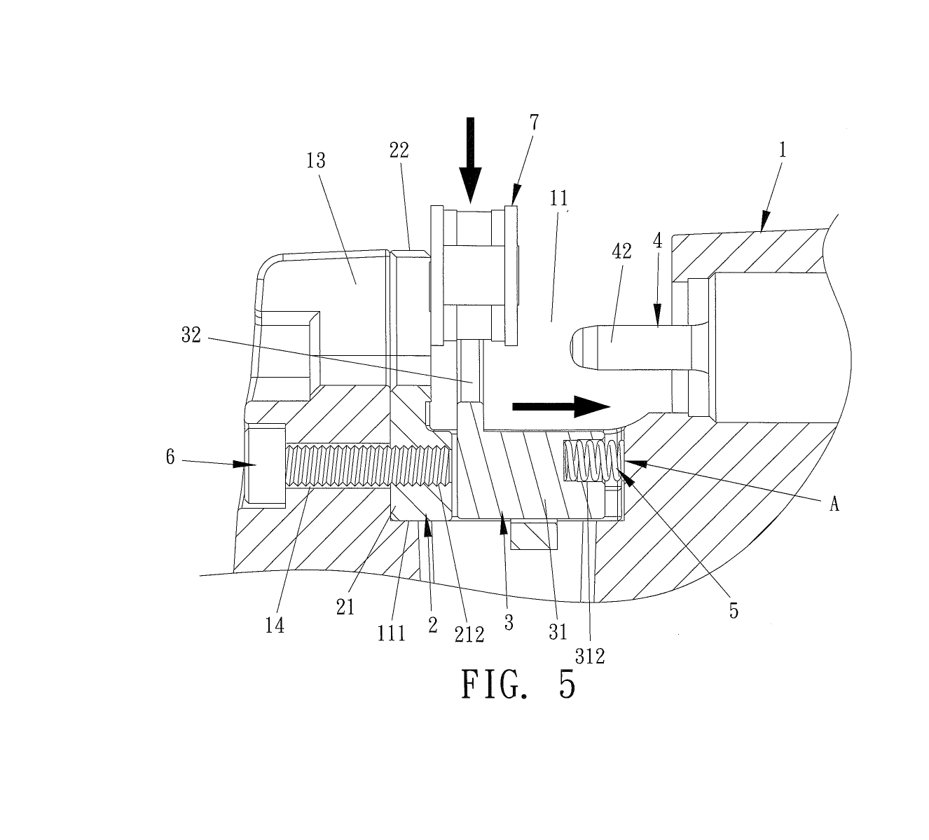

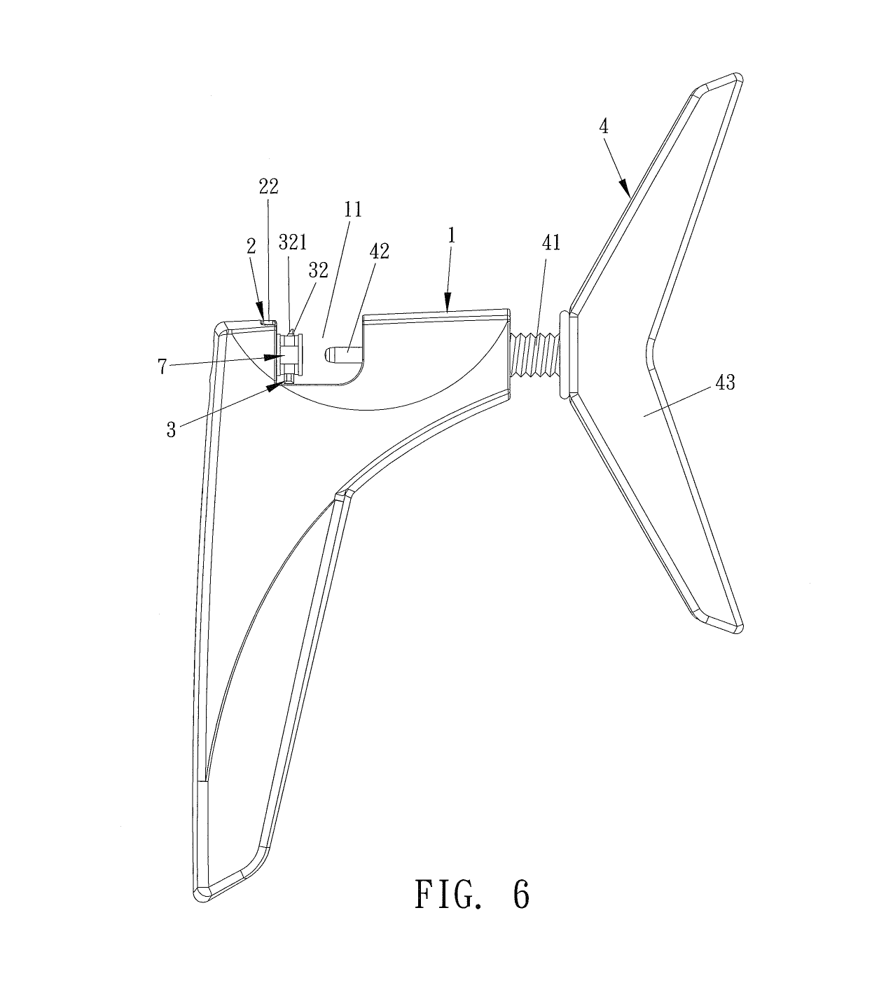

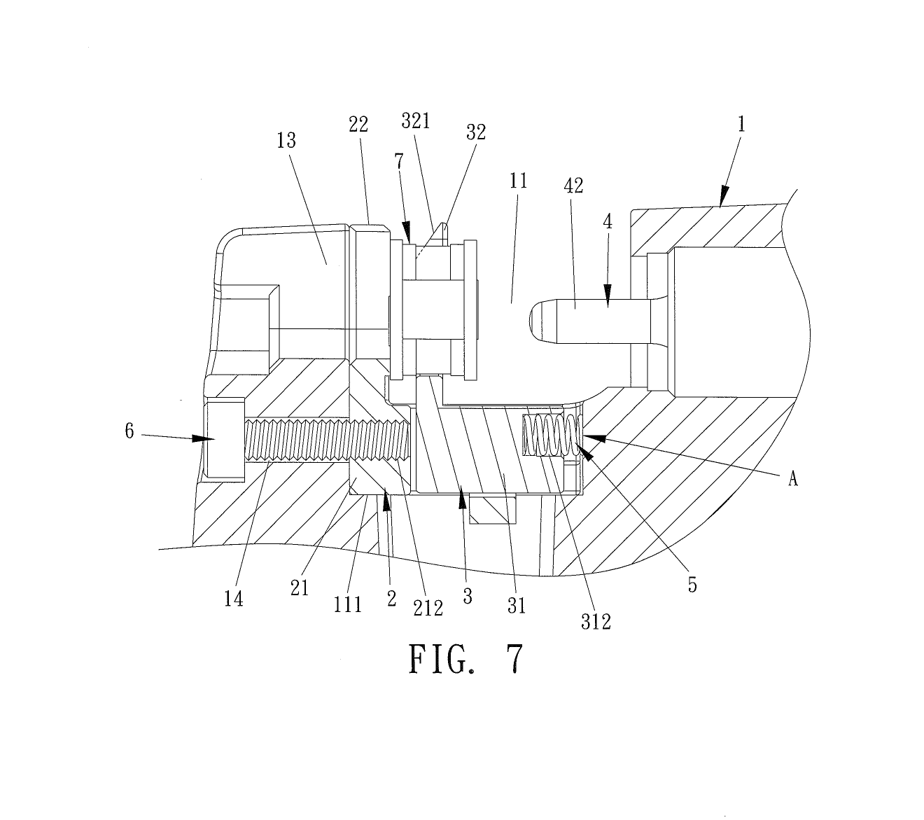

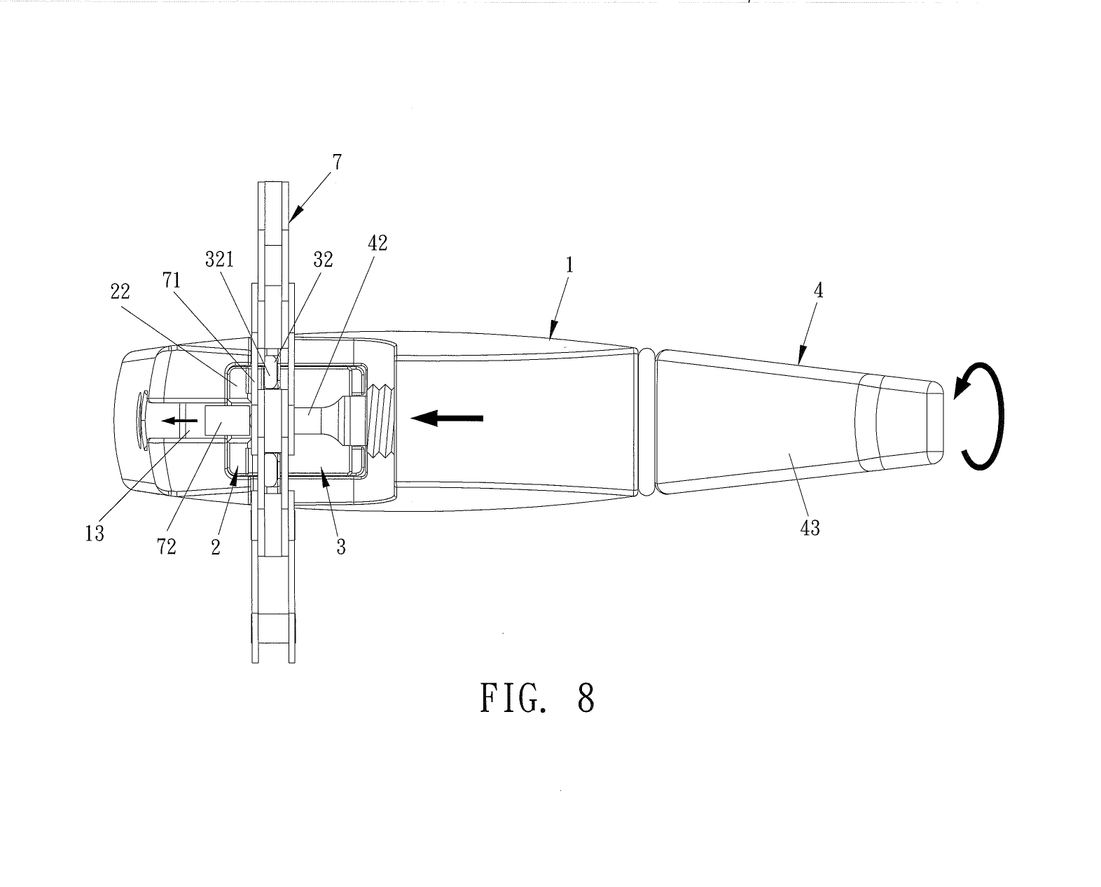

As shown in FIGS. 4-8, in operation, a chain 7 is placed on the longitudinal panel 32 of the movable seat 3 of the position adjustable chain tool so that the chain 7 is guided by the tilted guiding portion 321 of the longitudinal panel 32 which matches with the resilient element 5, and the movable seat 3 is pushed oppositely to the vertical extension 22 of the fixed holder 2. When the chain 7 is placed at a predetermined position, the movable seat 3 is pushed by the resilient element 5 so that a connecting piece 71 of the chain 7 is retained by the longitudinal panel 32 of the movable seat 3 and the vertical extension 22 of the fixed holder 2, such that a coupling pin 72 for removing the chain 7 aligns with the pushing portion 42 of the rotatable lever 4 and the U-shaped recess 13 of the body 1 without movement because of an external force, hence the rotatable lever 4 is rotate by rotating the rotary handle 43 to move forward, and then the pushing portion 42 pushes the coupling pin 72 of the chain 7 out of the U-shaped recess 13 of the body 1, thus removing the chain 7.

After removing the chain 7, the chain 7 separates from the position adjustable chain tool, and the movable seat 3 returns its original position by ways of the resilient element 5 to have a chain remove further.

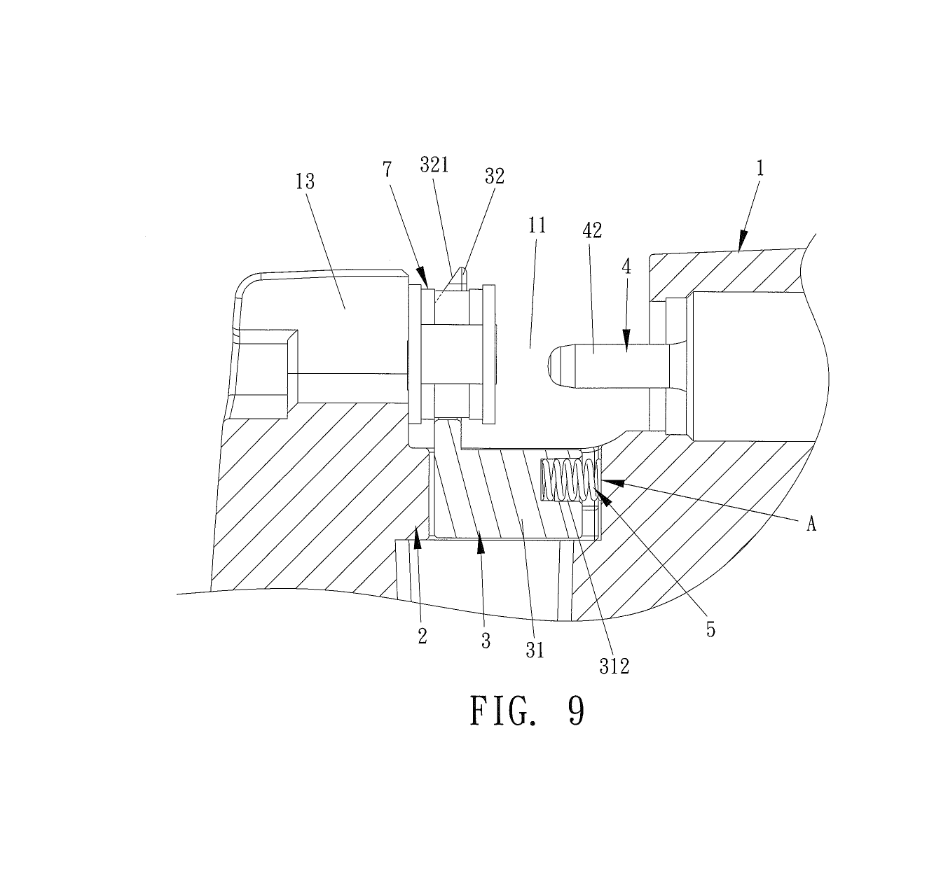

The body 1 and the fixed holder 2 are two independent components separated from each, and they are connected together as illustrated in FIGS. 1-8. Also, the body 1 and the fixed holder 2 are integrally formed together as shown in FIG. 9.

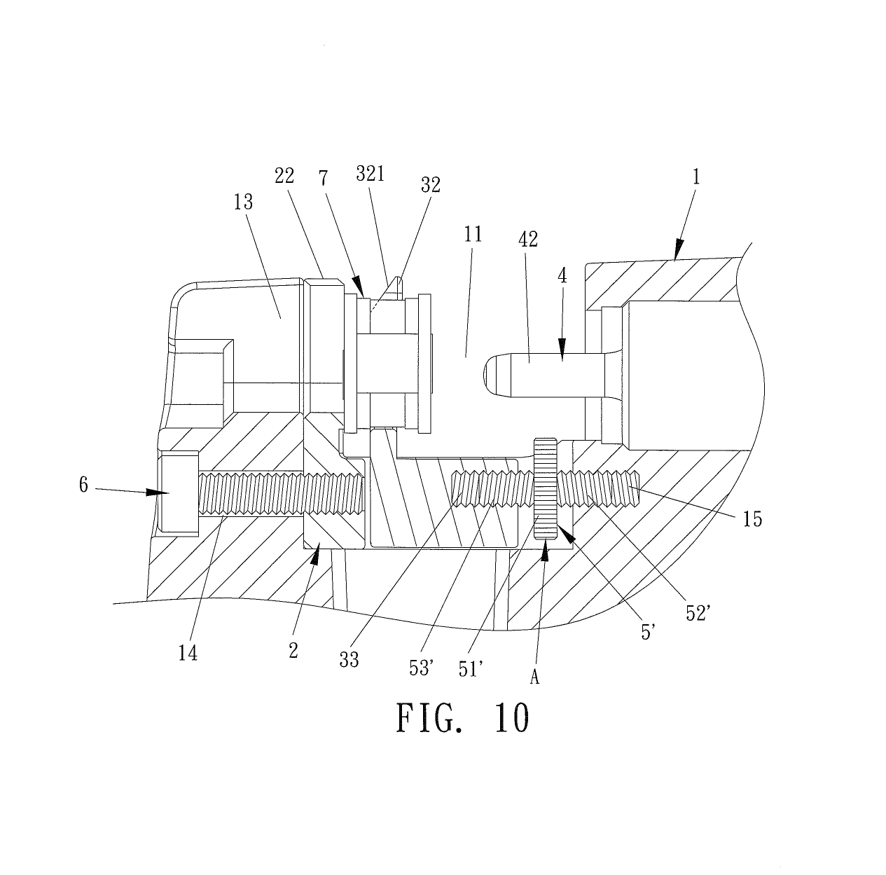

Referring further to FIG. 10, the displacement controlling means A contains an adjusting member 5′, a male opening 15, and a female opening 33; wherein the male opening 15 is defined on the body 1, the female opening 33 is formed on the movable seat 3; the adjusting member 5′ has an exposed rotating portion 51′, a male thread segment 52′ screwed with the male opening 15 and a female thread segment 53′ screwed with the female opening 33 so that the adjusting member 5′ is rotated to move the movable seat 3 between the fixed holder 2 and the through thread hole 12, thus removing the chain.

Thereby, the position adjustable chain tool of the prevent invention has the following advantages:

1. As removing the chain 7, the chain 7 is placed on the longitudinal panel 32 of the movable seat 3, and the movable seat 3 is moved toward the vertical extension 22 of the fixed holder 2 by using the displacement controlling means A so that the connecting piece 71 of the chain 7 is retained between the longitudinal panel 32 of the movable seat 3 and the vertical extension 22 of the fixed holder 2, hence the chain 7 is fixed at an alignment position without movement because of the external force, thus removing the chain easily and quickly.

2. The position adjustable chain tool is simplified to lower production cost.

While we have shown and described various embodiments in accordance with the present invention, it is clear to those skilled in the art that further embodiments may be made without departing from the scope of the present invention.

What is claimed is:

1. A position adjustable chain tool comprises:
a body including a fixed holder disposed on one side thereof, the fixed holder including a vertical extension, and the vertical extension having a cutout, the body including a through thread hole arranged on one side surface thereof and corresponding to the cutout;
a movable seat fixed between the fixed holder and the through thread hole, the movable seat having a horizontal sliding block and a longitudinal panel;
a displacement controlling means defined between the body and the movable seat to control the movable seat to move between the fixed holder and the through thread hole by ways of the horizontal sliding block; and
a rotatable lever including a thread rod screwed with the through thread hole of the body, the thread rod having a pushing portion on one end thereof to correspond to the cutout of the fixed holder, the pushing portion matching with the through thread hole by ways of the thread rod so that the pushing portion moves axially in the cutout.

2. The position adjustable chain tool as claimed in claim 1, wherein the displacement controlling means includes a notch and a resilient element, and the notch is defined on one end of the horizontal sliding block;
one end of the resilient element is fitted into the notch of the movable seat, and another end of the resilient element is biased against the body so that the movable seat is pushed toward the vertical extension of the fixed holder by the resilient element.

3. The position adjustable chain tool as claimed in claim 1, wherein the displacement controlling means contains an adjusting member, a male opening, and a female opening;
the male opening is defined on the body;
the female opening is formed on the movable seat;
the adjusting member has an exposed rotating portion, a male thread segment screwed with the male opening and a female thread segment screwed with the female opening so that the adjusting member is rotated to move the movable seat between the fixed holder and the through thread hole.

4. The position adjustable chain tool as claimed in claim 1, wherein the body includes a groove in which the fixed holder is fixed, and the through thread hole is defined on one side surface of the groove.

5. The position adjustable chain tool as claimed in claim 2, wherein the body includes a groove in which the fixed holder is fixed, and the through thread hole is defined on one side surface of the groove.

6. The position adjustable chain tool as claimed in claim 3, wherein the body includes a groove in which the fixed holder is fixed, and the through thread hole is defined on one side surface of the groove.

7. The position adjustable chain tool as claimed in claim 1, wherein the body includes a groove, and the through thread hole is defined on one side surface of the groove, the groove of the body has a U-shaped recess formed on another side surface thereof relative to the one side surface of the U-shaped groove.

8. The position adjustable chain tool as claimed in claim 2, wherein the body includes a groove, and the through thread hole is defined on one side surface of the groove, the groove of the body has a U-shaped recess formed on another side surface thereof relative to the one side surface of the U-shaped groove.

9. The position adjustable chain tool as claimed in claim 3, wherein the body includes a groove, and the through thread hole is defined on one side surface of the groove, the groove of the body has a U-shaped recess formed on another side surface thereof relative to the one side surface of the U-shaped groove.

10. The position adjustable chain tool as claimed in claim 1, wherein the body includes a groove, and the through thread hole is defined on one side surface of the groove, the groove of the body has a through orifice formed on the another side surface thereof relative to the one side surface of the U-shaped groove, the fixed holder includes a lateral extension and a vertical extension, the lateral extension has a screw aperture arranged on a side surface thereof, and the fixed holder is retained in the U-shaped groove of the body, and a screw is screwed into the screw aperture of the lateral extension via the through orifice of the body so that the fixed holder connects with the body.

11. The position adjustable chain tool as claimed in claim 2, wherein the body includes a groove, and the through thread hole is defined on one side surface of the groove, the groove of the body has a through orifice formed on the another side surface thereof relative to the one side surface of the U-shaped groove, the fixed holder includes a lateral extension and a vertical extension, the lateral extension has a screw aperture arranged on a side surface thereof, and the fixed holder is retained in the U-shaped groove of the body, and a screw is screwed into the screw aperture of the lateral extension via the through orifice of the body so that the fixed holder connects with the body.

12. The position adjustable chain tool as claimed in claim 3, wherein the body includes a groove, and the through thread hole is defined on one side surface of the groove, the groove of the body has a through orifice formed on the another side surface thereof relative to the one side surface of the U-shaped groove, the fixed holder includes a lateral extension and a vertical extension, the lateral extension has a screw aperture arranged on a side surface thereof, and the fixed holder is retained in the U-shaped groove of the body, and a screw is screwed into the screw aperture of the lateral extension via the through orifice of the body so that the fixed holder connects with the body.

13. The position adjustable chain tool as claimed in claim 1, wherein the body includes a groove, and the through thread hole is defined on one side surface of the groove, the also has an indentation defined therein to retain with the fixed holder, the fixed holder includes a lateral extension and a vertical extension, the lateral extension has two opposite slidable rails extending inward from two sides thereof, and the horizontal sliding block of the movable seat has two opposite slots formed thereon to retain with the two opposite slidable rails of the fixed holder.

14. The position adjustable chain tool as claimed in claim 2, wherein the body includes a groove, and the through thread hole is defined on one side surface of the groove, the also has an indentation defined therein to retain with the fixed holder, the fixed holder includes a lateral extension and a vertical extension, the lateral extension has two opposite slidable rails extending inward from two sides thereof, and the horizontal sliding block of the movable seat has two opposite slots formed thereon to retain with the two opposite slidable rails of the fixed holder.

15. The position adjustable chain tool as claimed in claim 3, wherein the body includes a groove, and the through thread hole is defined on one side surface of the groove, the also has an indentation defined therein to retain with the fixed holder, the fixed holder includes a lateral extension and a vertical extension, the lateral extension has two opposite slidable rails extending inward from two sides thereof, and the horizontal sliding block of the movable seat has two opposite slots formed thereon to retain with the two opposite slidable rails of the fixed holder.

16. The position adjustable chain tool as claimed in claim 1, wherein the longitudinal panel of the movable seat includes a tilted guiding portion disposed on an upper end thereof.

17. The position adjustable chain tool as claimed in claim 2, wherein the longitudinal panel of the movable seat includes a tilted guiding portion disposed on an upper end thereof.

18. The position adjustable chain tool as claimed in claim 3, wherein the longitudinal panel of the movable seat includes a tilted guiding portion disposed on an upper end thereof.
